(19) United States
(12) Patent Application Publication
(10) Pub. No.: US 2025/0099935 A1
(43) Pub. Date: Mar. 27, 2025

(54) IMPROVED EBULLATED BED REACTOR AND PROCESS

(71) Applicant: CHEVRON U.S.A. INC., San Ramon, CA (US)

(72) Inventors: Steven Xuqi SONG, El Cerrito, CA (US); Michael MCMULLIN, Sonoma, CA (US)

(21) Appl. No.: 18/728,876

(22) PCT Filed: Jan. 12, 2023
(86) PCT No.: PCT/US2023/060516

§ 371 Date: Jul. 13, 2024

Related U.S. Application Data
(60) Provisional application No. 63/299,406, filed on Jan. 13, 2022.

(51) Int. Cl. B01J 10/00; B01J 8/00; B01J 8/18

(52) U.S. Cl. CPC B01J 10/002; B01J 8/0035; B01J 8/1845; B01J 8/1872

(57) ABSTRACT

An improved ebullated bed reactor, a method for modifying an existing ebullated bed reactor to improve performance, and associated processes for improving the performance of ebullated reactors during hydroprocessing operation. In one aspect, the addition of a catalyst withdrawal outlet located at the top of the ebullated bed reactor allows for fine spent catalyst to be withdrawn during reactor operation and for certain performance improvements to be realized.

### CROSS REFERENCE TO RELATED APPLICATIONS

This application is related to and claims priority benefit from U.S. Provisional Patent Appl. Ser. No. 63/299,406, filed on Jan. 13, 2022, entitled “IMPROVED EBULLATED BED REACTOR AND PROCESS”, the disclosure of which is herein incorporated by reference in its entirety.

### FIELD OF THE INVENTION

The invention concerns an improved ebullated bed reactor, a method for modifying an existing ebullated bed reactor to improve performance, and associated processes for improving the performance of ebullated reactors during hydroprocessing operation.

### BACKGROUND OF THE INVENTION

Ebullated bed reactors are a type of fluidized bed reactor that utilizes ebullition, or bubbling, to achieve appropriate distribution of reactants and catalysts. Ebullated bed technology utilizes a three-phase reactor (liquid, vapor, and catalyst), and is most applicable for exothermic reactions and for feedstocks which are difficult to process in fixed-bed or plug flow reactors, including for feeds having higher levels of contaminants. Ebullated bed reactors generally provide high-quality, continuous mixing of liquid and catalyst particles and have the characteristics of stirred reactor type operation with a fluidized catalyst. The advantages of ebullated bed reactors include, e.g., good back-mixed bed performance, excellent temperature control, and low and constant pressure drops due to reduced bed plugging and channeling. Ebullated bed reactors are used in the hydroconversion of heavy petroleum and petroleum fractions, particularly vacuum residuum.

Catalysts used in ebullated bed reactors are typically millimeter-sized extrudates that are held in a fluidized state through the upward lift of liquid reactants and gas. Liquid and gas enter through a reactor plenum and are distributed across the catalyst bed through a distributor and grid plate. The height of the ebullated catalyst bed can be controlled by the rate of liquid recycle flow. This liquid rate is adjusted by varying the speed of the ebullating pump, e.g., a centrifugal pump that controls the flow of ebullating liquid obtained from an internal vapor/liquid separator inside the reactor. Fresh catalyst can be added to the reactor, while spent catalyst can be withdrawn from the bottom of the reactor. The regular addition of a small quantity of fresh catalyst generally allows the performance of ebullated bed reactors to maintain product quality over long time periods. The type of catalyst used can also be changed without shutting down the reactor so that the operation may be adjusted and/or different feedstocks may be used.

The catalyst used is held in a fluidized state through the upward lift of liquid reactants (feed oil plus recycle) and gas (hydrogen feed) which enter in the reactor plenum and are distributed across the bed through a distributor and grid plate. The height of the ebullated catalyst bed is controlled by the rate of liquid recycle flow. This liquid rate is adjusted by varying the speed of the ebullating pump (i.e., a centrifugal pump) which controls the flow of ebullating liquid obtained from the internal vapor/liquid separator inside the reactor.

Catalysts used in ebullated bed reactors typically have a cylindrical extrudate shape, with a diameter of about 1 mm and an L/D=1-6, or 2-4. Since catalyst activity is degraded in the reactor due to coke and metal deposition, periodical (daily) withdrawal and addition (about 1-5% of total inventory) are performed to maintain constant catalyst activity.

While ebullated bed reactor technology and designs have advanced over time, leading to certain improvements, a continuing need exists for improved processes to both utilize ebullated bed reactors for challenging feeds as well as for improved designs that provide improved ebullated bed performance in hydroprocessing applications.

### SUMMARY OF THE INVENTION

The present invention is directed to an improved ebullated bed reactor, a method for modifying an existing ebullated bed reactor to improve performance, and associated processes for improving the performance of ebullated reactors during hydroprocessing operation. While not necessarily limited thereto, one of the goals of the invention is to provide a relatively uncomplicated improved ebullated bed reactor design and a process of using the improved reactor to enhance the reactor operating performance.

In general, the ebullated bed (EB) reactor of the invention comprises a catalyst withdrawal outlet that is suitable for selectively withdrawing fine spent catalyst during operation of the reactor. Existing EB reactors may also be modified according to the invention by adding a catalyst withdrawal outlet that is suitable for selectively withdrawing fine spent catalyst during operation of the reactor. In some aspects, the invention provides the ability to improve performance in one or more ways through the reduction and/or removal of fine spent, fully or partially deactivated catalyst. Such improvements include, e.g., the reduction of catalyst sediment in product from the ebullated bed reactor; the reduction in axial catalyst segregation; or a combination thereof, as well as other advantageous benefits.

The improved ebullated reactor may, in some cases, comprise a catalyst withdrawal outlet located at the top of the EB reactor so that fine spent catalyst may be withdrawn from the top of the reactor during operation.

### BRIEF DESCRIPTION OF THE DRAWINGS

The scope of the invention is not limited by any representative figures accompanying this disclosure and is to be understood to be defined by the claims of the application.

FIG. 1 is an illustration of a conventional ebullated bed (EB) reactor including features according to the invention.

FIG. 2 is an illustration of the comparative particle size distribution realized for an inventive and comparative EB reactor as described in the Examples.

### DETAILED DESCRIPTION

Although illustrative embodiments of one or more aspects are provided herein, the disclosed processes may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

The term “Hydrogen” or “hydrogen” refers to hydrogen itself, and/or a compound or compounds that provide a source of hydrogen.

“Hydroprocessing” refers to a process in which a carbonaceous feedstock is brought into contact with hydrogen and a catalyst, at a higher temperature and pressure, for the purpose of removing undesirable impurities and/or converting the feedstock to a desired product. Examples of hydroprocessing processes include hydrocracking, hydrotreating, catalytic dewaxing, and hydrofinishing.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur and/or nitrogen-containing hydrocarbon feeds into hydrocarbon products with reduced sulfur and/or nitrogen content, typically in conjunction with hydrocracking, and which generates hydrogen sulfide and/or ammonia (respectively) as byproducts.

“Treatment,” “treated,” “upgrade,” “upgrading” and “upgraded,” when used in conjunction with an oil feedstock, describes a feedstock that is being or has been subjected to hydroprocessing, or a resulting material or crude product, having a reduction in the molecular weight of the feedstock, a reduction in the boiling point range of the feedstock, a reduction in the concentration of asphaltenes, a reduction in the concentration of hydrocarbon free radicals, and/or a reduction in the quantity of impurities, such as sulfur, nitrogen, oxygen, halides, and metals.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

The term “bulk catalyst” may be used interchangeably with “unsupported catalyst”, meaning that the catalyst composition is not a conventional catalyst form which has a preformed, shaped catalyst support which is then loaded with metals via impregnation or deposition catalyst. In one embodiment, the bulk catalyst is formed through precipitation. In another embodiment, the bulk catalyst has a binder incorporated into the catalyst composition. In yet another embodiment, the bulk catalyst is formed from metal compounds and without any binder. In a fourth embodiment, the bulk catalyst is a dispersing-type catalyst (“slurry catalyst”) for use as dispersed catalyst particles in mixture of liquid (e.g., hydrocarbon oil).

The term “heavy oil” feed or feedstock refers to heavy and ultra-heavy crudes, including but not limited to resids, coals, bitumen, tar sands, etc. Heavy oil feedstock may be liquid, semi-solid, and/or solid. Examples of heavy oil feedstock that might be upgraded as described herein include but are not limited to Canada Tar sands, vacuum resid from Brazilian Santos and Campos basins, Egyptian Gulf of Suez, Chad, Venezuelan Zulia, Malaysia, and Indonesia Sumatra. Other examples of heavy oil feedstock include residuum left over from refinery processes, including “bottom of the barrel” and “residuum” (or “resid”) atmospheric tower bottoms, which have a boiling point of at least 343° C. (650° F.), vacuum tower bottoms, which have a boiling point of at least 524° C. (975° F.), or “resid pitch” and “vacuum residue”, which have a boiling point of 524° C. (975° F.) or greater.

In this disclosure, while compositions and methods or processes are often described in terms of “comprising” various components or steps, the compositions and methods may also “consist essentially of” or “consist of” the various components or steps, unless stated otherwise.

The terms “a,” “an,” and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

In one aspect, the present invention is directed to a new ebullated bed (EB) reactor in which a catalyst withdrawal outlet is suitably located to enable the withdrawal of fine spent catalyst during operation of the reactor. While not necessarily limited thereto, the term “fine spent catalyst” is intended to refer to the catalyst withdrawn from the top withdrawal outlet. Typically, such withdrawn catalyst particles have sizes ranging from about 0.01 to 3 mm, or 0.1 to 1 mm (depending, in part, on the size of fresh catalyst), including broken pieces of extrudate catalyst. In addition, catalyst solids referred to as “ultrafine solids” having particle sizes of less than about 0.01 mm will be carried out of the reactor in the liquid product as inorganic sediment. The catalyst withdrawal outlet may be conveniently located on or near the top of the EB reactor. A tube, pipe, or other catalyst withdrawal conduit is positioned to have one end opening within the operating EB bed height and the other end connected to the catalyst withdrawal outlet so that fine spent catalyst may flow through the tube, pipe, or other conduit and be withdrawn from the reactor through the catalyst withdrawal outlet. In contrast to conventional ebullated bed (EB) reactors, in which operationally active catalyst is normally withdrawn during operation from the bottom of the EB reactor, the present EB reactor allows for fine spent catalyst to be preferentially withdrawn from the reactor while the remaining active catalyst is largely left within the reactor.

The terms “operationally active catalyst” (used in reference to conventional EB reactors herein), and “fine spent catalyst” and “remaining active catalyst” (used in reference to the inventive EB reactor as described herein) are relative terms, and depend on various parameters, including, e.g., the fresh catalyst characteristics, reactor operation conditions, and catalyst withdrawal procedures and conditions. In a conventional EB reactor, i.e., an EB reactor not having a top fine spent catalyst withdrawal outlet according to the invention, spent catalyst is withdrawn from the bottom of the reactor and is typically larger in size and has a greater density compared to the average catalyst characteristics in the EB reactor. Catalyst that remains in a conventional EB reactor is considered to be operationally active since, on average, the remaining catalyst particles possess an activity that is within operational specifications. In contrast, the withdrawal of “fine spent catalyst” from the top of an EB reactor according to the invention removes smaller size catalyst particles that typically have a greater density than the average catalyst in the reactor, i.e., the “remaining active catalyst”. Such “fine spent catalyst” typically has little to no remaining catalytic activity and its withdrawal results in an increased average particle size in the remaining active catalyst within the reactor and improved overall catalytic activity.

The term “fine spent catalyst” may be generally characterized in terms of average particle size or particle size range, or on a percentage basis, relative to the particle size of fresh catalyst. For example, on a percentage basis, “fine spent catalyst” may be in the range of up to about 30%, or 20%, or 10%, or 5%, or 2%, or 1% of the average particle size, particle size range, and/or length/diameter (L/D) or L/D range of fresh catalyst. For typical EB extrudate catalyst particles, e.g., including catalysts having diameters of approximately 1 mm and an L/D=1-6, or 2-4, “fine spent catalyst” particle sizes typically vary from about 0.01 to 3 mm, or 0.1 to 1 mm.

The present invention is also suitable for modifying existing conventional EB reactors, in which catalyst is withdrawn from the bottom of the EB reactor, through the installation of a catalyst withdrawal outlet, which, in some cases, may be located at or near the top of the EB reactor. The modified EB reactor is also modified to include a tube, pipe, or other catalyst withdrawal conduit connected to the catalyst withdrawal outlet so that fine spent catalyst may flow through the tube, pipe, or other conduit and be withdrawn from the reactor through the catalyst withdrawal outlet during operation of the EB reactor.

The invention further relates to a method for improving the performance of an ebullated bed (EB) reactor, wherein the method provides for at least one improvement comprising the reduction and/or removal of fine spent, fully or partially deactivated catalyst; the reduction of catalyst sediment in product from the ebullated bed reactor; the reduction in axial catalyst segregation; or a combination thereof; the method comprising selectively withdrawing fine spent catalyst from a catalyst withdrawal outlet during operation of the EB reactor.

Among the advantages associated with the present EB reactor, the present modified EB reactor, and/or the present method, are the reduction and/or removal of fine spent, fully or partially deactivated catalyst from the EB reactor during operation; the reduction of catalyst sediment in product from the EB reactor; the reduction in axial catalyst segregation during operation of the EB reactor; the improvement in reactor volume utilization; the improvement in reactor operating efficiency and/or catalyst activity; the improvement in the ability to maintain a well-defined interface between 2-phase and 3-phase zones during reactor operation; the reduction in catalyst attrition rate; and the reduction in the risk of reactor instability and/or loss of catalyst bed level control. Such advantages include combinations of each of the foregoing noted advantages.

In certain embodiments, the present EB reactor and/or modified EB reactor includes a catalyst withdrawal tube, pipe, or other catalyst conduit that extends into the expanded catalyst bed during operation, in some embodiments at least about 2%, or 4% or 6%, or 10%, or 20%, or 30%, or 40%, or 50% below the top of the expanded catalyst bed during operation, wherein the distance below the top surface is expressed as the percentage of the total expanded bed height While not necessarily limited thereto or required, typical embodiments for catalyst withdrawal tube dimensions may include a diameter in the 2-6 in. range, or, more particularly, in the 2-4 in. diameter range. The catalyst withdrawal tube may also be positioned so that the tube opening faces downward. During reactor operation, hydrogen may be passed downward through the tube when catalyst is not being withdrawn to reduce coke formation.

In another aspect, the invention relates to operation of the present EB reactor, and/or the modified EB reactor in which fine spent catalyst may be continuously or periodically withdrawn from the EB reactor during operation. For example, periodic fine spent catalyst withdrawal may be scheduled to allow for a percentage or amount of the fine spent catalyst to be withdrawn from the EB reactor to enable the improvements noted herein to be realized. Continuous withdrawal is also possible and may allow for more automated process control of EB reactor operation.

During EB reactor operation, the constant movement of the catalyst particles within the bed causes attrition, with the catalyst particles very slowly eroding and breaking into smaller pieces. Some of these very small catalyst fines are constantly leaving the reactor with the process effluent. Some very short catalyst particles, or fines, however, are not small enough to be carried out the reactor by the process effluent, and may concentrate at the top of the catalyst bed and even separate from the bulk of the catalyst bed population. This accumulation of fine spent catalyst at the top of the reactor bed can create operational problems. For example, level indicating density detectors used to detect the normal operation expanded catalyst bed height may misinterpret the fine spent catalyst at the reactor bed top as the catalyst bed normal expanded bed height and reduce the recycle pump speed, thereby allowing the bulk of the catalyst bed to settle onto the distribution grid.

Inorganic sediment from catalyst attrition in the liquid product can also cause fouling in downstream equipment, such as in heat exchangers and distillation columns. Withdrawal of fine spent catalyst fines at the surface of the ebullated bed can reduce the entrainment to the internal recycle pump, and reduce the amount of ultra-fines carried out by the liquid product to downstream equipment.

Axial catalyst segregation can also become a problem during conventional EB reactor operation. For example, while axial catalyst segregation in size and density exists in an EB reactor, and may provide some benefits, such segregation may also promote plug-flow like catalyst migration from fresh catalyst at the top of the catalyst bed to an accumulation of the most spent catalyst at the bottom of the reactor bed (i.e., where the conventional catalyst withdrawal nozzle is located). As such, axial catalyst segregation may also lead to an accumulation of fine spent catalyst at the top bed surface, with little to no migration of such fine spent catalyst to the bottom withdrawal nozzle due to the smaller size.

The present invention also provides beneficial improvements in reactor operating efficiency and/or overall catalyst activity. For example, in normal EB operation and maintenance, the reactor is emptied for maintenance reactor catalyst de-inventory with a certain amount of spent catalyst rejected for disposal and the remaining catalyst retained for the next run cycle. The first few batches of spent catalyst withdrawn from the bottom of the conventional EB reactor are heavily loaded with metal contamination at higher density and are rejected for disposal. The same amount of fresh catalyst makeup is then added when the EB reactor operation is restarted.

During one EB reactor turnaround maintenance cycle, however, the same amount of spent catalyst according to a previous run cycle was withdrawn during a trial run, but with the total rejected catalyst split between the beginning and the end of the catalyst de-inventory operation. The same amount of spent catalyst was withdrawn and rejected but from both the bottom and the top of the bed rather than from just the bottom withdrawal outlet (according to the usual maintenance cycle procedure). After new operation cycle startup, the activity of catalyst in the reactor was found to be higher than previous cycle, and the fresh catalyst addition rate was lower than the previous cycle. This surprising result demonstrated the fine spent catalyst in the upper reactor zone has lower catalytic activity and that the reactor operating efficiency can be removed.

The risk of reactor instability and loss of a well-defined interface between 2-phase and 3-phase zones during reactor operation is a concern with conventional EB reactor operation. In general, catalyst bed expansion depends on the liquid flow supplied through the internal recycle pump, and the internal recycle pump rotation speed (liquid flow rate) that is controlled by the elevation of the interface between the 2-phase and 3-phase zones. The accumulation of fine spent catalyst at the interface may potentially lead to false signals to the pump to reduce or increase pump speeds. Indeed, in at least one incident, the reduction in internal recycle pump speed led to catalyst bed settling in the 3-phase zone, resulting in hot spot formation, forced emergency shutdown, and lost production for several days. Removing the catalyst fines at the 2-phase/3-phase interface according to the invention provides the ability to avoid such incidents and improve the EB reactor operational reliability.

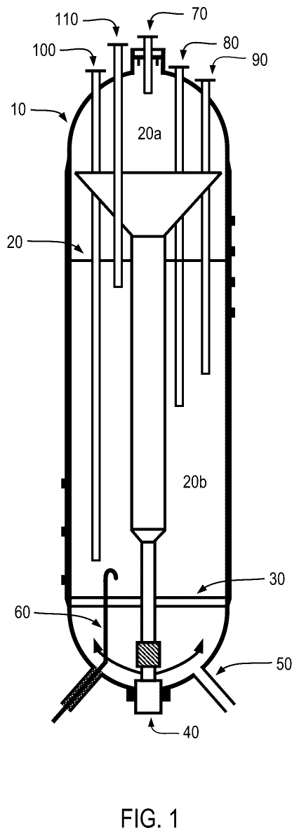

An illustration of an ebullated bed (EB) reactor, or a modified EB reactor, according to the invention is shown in FIG. 1. In FIG. 1, EB reactor 10 includes a top 2-phase gas/liquid zone 20a and a bottom 3-phase gas/liquid/solid zone 20b, in which the normal expanded catalyst bed height 20 separates the two zones. Distributor grid 30 is located in the lower region of the reactor and contains the catalyst within the 3-phase zone 20b. Recycle pump 40, gas/liquid feed inlet 50, and bottom catalyst withdrawal line 60 are shown located at the bottom of the reactor. Reactor effluent outlet 70, catalyst addition inlet 80, density detector source well 90, and thermowell nozzle 100 are located at the top of the reactor. Top catalyst withdrawal outlet 110 is also shown as being located at the top of the reactor with the withdrawal line extending to below the top surface of the expanded catalyst bed height 20.

Catalysts suitable for in use the EB reactor and associated processes include any of the suitable catalyst that are conventionally used in EB reactors. Various suitable catalysts are described in the patent literature, including, e.g., U.S. Pat. Nos. 9,206,361; 9,169,449 (further details regarding particulate catalysts may be found in U.S. Pat. Nos. 7,803,266; 7,185,870; 7,449,103; 8,024,232; 7,618,530; 6,589,908; 6,667,271; 7,642,212; 7,560,407; 6,030,915; 5,980,730; 5,968,348; 5,498,586; and US Patent Publication Nos. 2011/0226667. 2009/0310435; and 2011/0306490. Although not limited thereto, the catalyst used in the ebullated bed is typically a millimeter diameter-sized extrudate comprising nickel-molybdenum active metals.

### EXAMPLES

Model studies and commercial EB reactor operation trials were undertaken to evaluate catalyst particle segregation and the benefits of removing fine spent catalyst from operating EB reactors.

### Example 1

Studies were conducted on tubular reactor cold flow models and compared with operating EB reactor performance to assess catalyst particle segregation dynamics. In one study, a 2 in. ID column was used to study catalyst segregation under ebullating bed conditions that are hydrodynamically similar to those of an operating EB reactor. While EB reactor operation has previously been considered to occur under fully back-mixed conditions with minimal axial segregation (along the length of the reactor, top to bottom), these studies have shown axial segregation of catalyst in size and density does occur under typical bed expansion and gas/liquid velocities.

### Example 2

During operation of a commercial EB reactor, catalyst was withdrawn from the top of the reactor and from the bottom of the reactor to compare the particle size distributions. The bottom catalyst sample was removed from just above the distributor grid tray and the top catalyst sample was removed at about 2 m below the top of the expanded catalyst bed surface. Particle sizes and distributions were determined by Cam Sizer analysis, after the samples were Soxhlet solvent washed with toluene.

Results are presented in Table 1 for both top and bottom catalyst withdrawals.

TABLE 1

| | Spent Catalyst Top | Spent Catalyst Bottom |
|---|---|---|
| Catalyst | Withdrawal | Withdrawal |
| L/D | (Vol %) | (Vol %) |
| 0.429 | 1.503 | 0.303 |
| 0.934 | 8.437 | 3.003 |
| 1.100 | 10.425 | 4.820 |
| 1.302 | 9.215 | 5.568 |
| 1.565 | 13.323 | 9.622 |
| 1.868 | 12.703 | 11.431 |
| 2.201 | 13.212 | 14.067 |
| 2.604 | 12.085 | 15.655 |
| 3.104 | 9.349 | 14.617 |
| 3.710 | 5.438 | 10.516 |
| 4.417 | 2.711 | 5.978 |
| 5.224 | 1.048 | 2.571 |
| 6.006 | 0.322 | 0.921 |
| 6.562 | 0.066 | 0.302 |
| 7.420 | 0.149 | 0.454 |
| 8.682 | 0.008 | 0.108 |
| 9.489 | 0.000 | 0.008 |
| 9.893 | 0.000 | 0.008 |
| 10.095 | 0.006 | 0.048 |

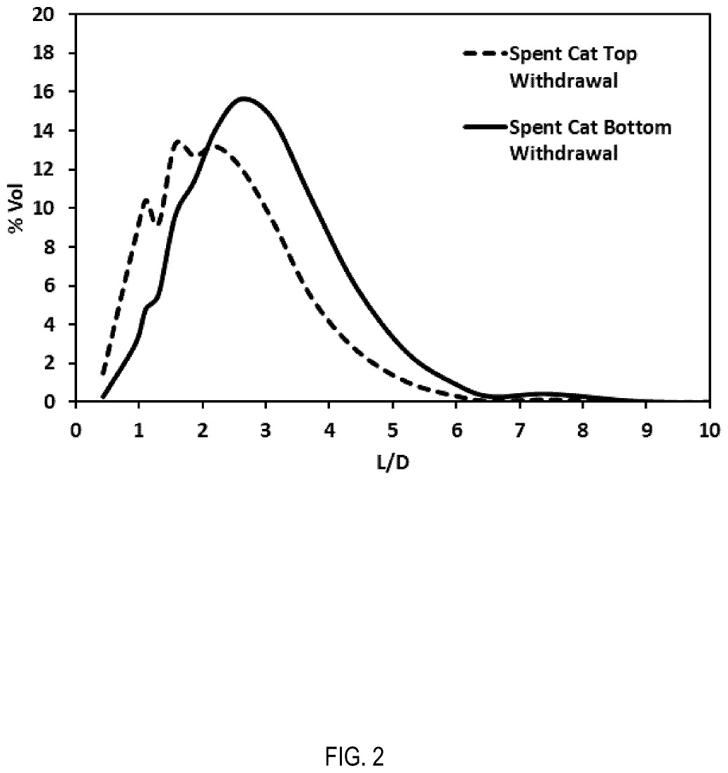

FIG. 2 shows the particle size distribution (L/D) for spent catalyst withdrawn from the top of an operating EB reactor and for catalyst withdrawn from the bottom of the same reactor. From FIG. 2, it can be seen that the particle size distribution for the fine spent catalyst withdrawn from the top of the reactor is shifted toward lower L/D particle sizes, whereas catalyst withdrawn from the bottom of the reactor has a larger L/D particle size distribution.

### Example 3

During operation of a commercial EB reactor system, approximately 10% of the equilibrium catalyst from each of three EB reactors was discarded and replaced with fresh catalyst. Results indicate that the oldest and most inactive spent catalyst was discarded. Following a return to operation, the units demonstrated improved performance at the same normal reactor temperatures and liquid hourly space velocity (LHSV) compared to previous operation, including a 560° C. conversion increase between 5-7%, a total reactor exotherm increase of approximately 6% across a three EB reactor system, and an overall hydrodesulfurization (HDS) improvement of approximately 3%. Further assessment of these improvements indicated that withdrawal of fine spent catalyst from the top of the reactor bed would provide a reduction in the population of lower activity catalyst (i.e., smaller catalyst particles) present in the reactor, leading to the noted performance improvements.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1-15. (canceled)

16. An ebullated bed reactor comprising a catalyst withdrawal outlet that is suitable for selectively withdrawing fine spent catalyst during operation of the ebullated bed reactor.

17. A modified ebullated bed reactor, comprising an existing ebullated bed reactor that has been modified by adding a catalyst withdrawal outlet that is suitable for selectively withdrawing fine spent catalyst during operation of the ebullated bed reactor.

18. A method for improving the performance of an ebullated bed reactor, wherein the method provides for at least one improvement comprising the reduction and/or removal of fine spent, fully or partially deactivated catalyst; the reduction of catalyst sediment in product from the ebullated bed reactor; the reduction in axial catalyst segregation; or a combination thereof; the method comprising selectively withdrawing fine spent catalyst from a catalyst withdrawal outlet during operation of the ebullated bed reactor.

19. The ebullated bed reactor of claim 16, wherein a catalyst withdrawal outlet is located at the top of the reactor and fine spent catalyst is withdrawn therefrom.

20. The modified ebullated bed reactor of claim 17, wherein a catalyst withdrawal outlet is located at the top of the reactor and fine spent catalyst is withdrawn therefrom.

21 The method of claim 18, wherein a catalyst withdrawal outlet is located at the top of the reactor and fine spent catalyst is withdrawn therefrom.

22. The ebullated bed reactor of claim 16, wherein the fine spent catalyst has a length/diameter (L/D) in the range of up to about 30%, or 20%, or 10%, or 5%, or 2%, or 1% of the length/diameter (L/D) or L/D range of fresh catalyst used in the reactor.

23. The ebullated bed reactor of claim 16, wherein the reactor volume utilization is improved due to the withdrawal of fine spent catalyst from the catalyst withdrawal outlet.

24. The ebullated bed reactor of claim 16, wherein the reactor operating efficiency and/or catalyst activity is improved due to the withdrawal of fine spent catalyst from the catalyst withdrawal outlet.

25. The ebullated bed reactor of claim 16, wherein the catalyst attrition rate is reduced due to the withdrawal of fine spent catalyst from the catalyst withdrawal outlet.

26. The ebullated bed reactor of claim 16, wherein the risk of reactor instability and/or loss of catalyst bed level control is reduced due to the withdrawal of fine spent catalyst from the catalyst withdrawal outlet.

27. The ebullated bed reactor of claim 16, wherein the ability to maintain a well-defined interface between 2-phase and 3-phase zones during reactor operation is increased due to the withdrawal of fine spent catalyst from the catalyst withdrawal outlet.

28. The ebullated bed reactor of claim 16, wherein the catalyst withdrawal outlet comprises a catalyst withdrawal pipe extending from the top of the reactor into the catalyst zone within the reactor during operation of the reactor.

29. The modified ebullated bed reactor of claim 17, wherein the catalyst withdrawal outlet comprises a catalyst withdrawal pipe extending from the top of the reactor into the catalyst zone within the reactor during operation of the reactor.

30. The method of claim 18, wherein the catalyst withdrawal outlet comprises a catalyst withdrawal pipe extending from the top of the reactor into the catalyst zone within the reactor during operation of the reactor.

31. The ebullated bed reactor of claim 28, wherein the catalyst withdrawal pipe extends up to about 50%, or 40%, or 30%, or 20%, or 10%, or 5%, or 2%, or 1% of the expanded catalyst bed height during operation.

32. The ebullated bed reactor of claim 16, wherein the catalyst withdrawal outlet is configured for continuous or periodic withdrawal of fine spent catalyst.

33. The method of claim 18, wherein catalyst is selectively withdrawn by periodically withdrawing catalyst from the catalyst withdrawal outlet.

34. The method of claim 33, wherein the periodic withdrawal of catalyst is based on the batchwise withdrawal of a portion of fine spent catalyst.
